(19) United States
(12) Patent Application Publication
(10) Pub. No.: US 2026/0317118 A1
(43) Pub. Date: Oct. 15, 2026

(54) METHOD FOR DETERMINING TORQUE SCALING FACTOR FOR ELEVATOR MOTION CONTROL SYSTEM, ELEVATOR MOTION CONTROL SYSTEM, ELEVATOR SYSTEM, AND COMPUTER PROGRAM PRODUCT

(71) Applicant: KONE CORPORATION, Helsinki (FI)

(72) Inventor: Janne SALOMÄKI, Helsinki (FI)

(73) Assignee: KONE CORPORATION, Helsinki (FI)

(21) Appl. No.: 19/444,818

(22) Filed: Jan. 9, 2026

Related U.S. Application Data
(63) Continuation of application No. PCT/EP2023/073120, filed on Aug. 23, 2023.

(51) Int. Cl. B66B 1/30; B66B 5/00; B66B 19/00

(52) U.S. Cl. CPC B66B 1/304; B66B 5/0037; B66B 19/00

(57) ABSTRACT

A method determines a torque scaling factor for an elevator motion control system connected to and configured to operate an elevator motor. The method includes performing a test run of an elevator car in an elevator shaft of an elevator system by utilizing the elevator motion control system and the elevator motor. The test run includes a constant speed portion into a first direction and a constant speed portion into an opposite second direction, determining, average values of torque references used in the elevator motion control system during the constant speed portions, determining, average motor mechanical power values of the elevator motor during the constant speed portions, and determining, the torque scaling factor based on the determined average torque references, the determined average motor mechanical power values, and a speed during the constant speed portions.

### FIELD OF THE INVENTION

The present invention relates in general to motion control in elevator systems. In particular, however, not exclusively, the present invention concerns determining a torque scaling factor for an elevator motion control system.

### BACKGROUND

A smooth start of an elevator requires a precisely preset, starting motor torque when opening the brakes keeping the elevator car in place. If the starting motor torque is not correct, an unintentional jerky movement upwards or downwards in the start occurs.

In known solutions, the starting motor torque is calculated based on elevator parameters, measured load and elevator car position. The motor is then controlled to provide the starting motor torque. However, the torque production of a controller and a motor may not be ideal. The torque accuracy depends on many things like accuracy of current and voltage sensors and motor parameters. In order to set the starting motor torque accurately, the torque scaling factor must be known. In known solutions, the torque scaling factor is tuned manually by a commissioning or maintenance person. The tuning procedure is time consuming, and the result depends on the commissioning person's skill. There is thus still a need to develop solutions for determining the torque scaling factor more easily and more accurately.

### SUMMARY

An objective of the present invention is to provide a method for determining a torque scaling factor for an elevator motion control system, an elevator motion control system, an elevator system, and a computer program product. Another objective of the present invention is that the method, the elevator motion control system, the elevator system, and the computer program product provide an easy and accurate way of determining the torque scaling factor.

The objectives of the invention are reached by a method for determining a torque scaling factor for an elevator motion control system, an elevator motion control system, an elevator system, and a computer program product as defined by the respective independent claims.

According to a first aspect, a method for determining a torque scaling factor for an elevator motion control system is provided. The elevator motion control system is connected to and configured to operate an elevator motor.

The method comprises:
performing a test run of an elevator car in an elevator shaft of an elevator system by utilizing the elevator motion control system and the elevator motor, wherein the test run comprises a constant speed portion into a first direction and a constant speed portion into an opposite second direction, determining, such as by an elevator motion controller, average values of torque references used in the elevator motion control system during the constant speed portions,
determining, such as by an elevator motion controller, average motor mechanical power values of the elevator motor during the constant speed portions, and
determining, such as by an elevator motion controller, the torque scaling factor based on the determined average torque references, the determined average motor mechanical power values, and a speed during the constant speed portions, for example, an absolute value of the speed.

The torque scaling factor may be a relation between a torque reference and an output power of the elevator motor. Furthermore, the torque scaling factor may be a ratio of the torque reference of the elevator motion control system to the output power, the output power being mechanical output power.

The test run may include only a part of the elevator shaft in the longitudinal direction thereof with an elevator car with an empty load, or the test run may be a ride between the bottom floor and the top floor with an elevator car with an empty load, that is cover the whole elevator shaft.

Regarding the constant speed portions, in them, the elevator car may preferably be arranged to move past the middle point of the elevator shaft. Thus, the test run should at least cover the section of the elevator shaft comprising the middle point, regardless of whether the test run includes only a part of the shaft or the whole shaft.

Alternatively or in addition, in both of the constant speed portions, that is in both directions, the elevator car may be arranged to move in the same section of the elevator shaft. Thus, the start and end points of the constant speed regions are the same positions relative to the shaft in both cases, when moving to the first or to the opposite second direction.

In various embodiments, the speed of the elevator car during the constant speed portions may be a pre-defined estimate speed. Thus, it may be assumed that the elevator motion control system moves the elevator car at said pre-defined estimate speed.

In some embodiments, the method may comprise determining the speed based on measuring a rotational speed of the elevator motor. For example, a motor encoder may be used to measure the rotational speed.

In some other embodiments, the method may comprise determining the speed based on measuring speed of the elevator car and using one or more mechanical force transmission parameters related to force transmission between the elevator motor and the elevator car. The speed may be measured, for example, by a speed sensor arrangement connected to the elevator car and the elevator shaft.

In an embodiment, the torque scaling factor may be determined based on the following equation:

$${K}_{T} = \frac{{T}_{REF , UP} + {T}_{REF , DOWN}}{{P}_{MOTOR , UP} - {P}_{MOTOR , DOWN}} . \frac{{V}_{TEST} \cdot {I}_{R}}{R} ,$$

where K_{T} is the torque scaling factor, T_{REF,UP} is the average value of torque reference during the constant speed portion into the first direction, T_{REF,DOWN} is the average value of torque reference during the constant speed portion into the opposite second direction, P_{MOTOR,UP} is the average motor mechanical power value during the constant speed portion into the first direction, P_{MOTOR,DOWN} is the average motor mechanical power value during the constant speed portion into the opposite second direction, V_{TEST} is the speed during the constant speed portions, IR is a roping ratio of the elevator system, and R is a radius of a traction sheave of the elevator system.

In various embodiments, the method may comprise determining the motor mechanical power based on a stator resistance of the elevator motor, and on a motor current and a motor voltage during the constant speed portions. In addition, the determining of the motor mechanical power may be based on an alpha-beta transformation of motor phase currents and motor phase voltages.

For example, the determining of the motor mechanical power may be based on the following equation:

$${P}_{motor} = \frac{3}{2} ( {i}_{S α} \cdot {u}_{S α} + {i}_{S β} \cdot {u}_{S β} ) - \frac{3}{2} {R}_{S} ( {i}_{S α}^{2} + {i}_{S β}^{2} ) ,$$

where i_{Sα} and i_{Sβ} are the alpha-beta transformations of the phase currents of a motor stator, and u_{Sα} and u_{Sβ} are the alpha-beta transformations of the phase voltages of a motor stator, and R_{S} is the stator resistance of the elevator motor.

In various embodiments, the method may comprise scaling a torque feedforward used in the elevator motion control system by the determined torque scaling factor. In addition, the scaling may comprise scaling a speed controller output of the elevator motion control system by the determined torque scaling factor.

Furthermore, the method may comprise measuring one or more motor currents by one or more current sensors, and transmitting measurement results of said measuring to an elevator motion controller of the elevator motion control system.

Alternatively or in addition, the method may comprise measuring one or more motor voltages by one or more voltage sensors, and transmitting measurement results of said measuring to an elevator motion controller of the elevator motion control system.

In various embodiments, the determination of the average values of torque references, the average motor mechanical power values, and, subsequently, the torque scaling factor may be performed by an elevator motion controller of the elevator motion control system, the elevator motion controller being connected to the electric converter unit.

The elevator motion controller may be configured to provide the scaled torque reference, which has been scaled by the determined torque scaling factor, to the electric converter unit.

According to a second aspect, an elevator motion control system is provided. The elevator motion control system comprises an elevator motion controller connected to an electric converter unit for operating an elevator motor. The elevator motion control system is configured to:
perform a test run of an elevator car in an elevator shaft of an elevator system by utilizing the elevator motion control system and the elevator motor, wherein the test run comprises a constant speed portion into a first direction and a constant speed portion into an opposite second direction,
determine average values of torque references used in the elevator motion control system during the constant speed portions,
determine average motor mechanical power values of the elevator motor during the constant speed portions, and
determine the torque scaling factor based on the determined average torque references, the determined average motor mechanical power values, and a speed during the constant speed portions, for example, an absolute value of the speed.

According to a third aspect, an elevator system is provided. The elevator system comprises an elevator car movable in an elevator shaft by an elevator motor, and an elevator motion control system in accordance with the second aspect, wherein the electric converter unit is connected to the elevator motor.

According to a fourth aspect, a computer program product is provided. The computer program product comprising instructions which, when the program is executed by a processor unit of an elevator motion control system, cause the elevator motion control system to carry out the method in accordance with the first aspect.

The present invention provides a method for determining a torque scaling factor for an elevator motion control system, an elevator motion control system, an elevator system, and a computer program product. The present invention provides advantages over known solutions in that the torque scaling factor can be determined, or estimated, more easily and still accurately. Furthermore, the process of determining the torque scaling factor can be automated so that the accuracy does not depend on the skill level of a commissioning or maintenance person.

Various other advantages will become clear to a skilled person based on the following detailed description.

The expression “a plurality of” may refer to any positive integer starting from two (2), that is two, at least two, three, at least three, etc.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 shows a flow diagram of a method according to an embodiment of the present invention.

FIG. 2 illustrates schematically an elevator motion control system.

FIG. 3 illustrates schematically characteristics of a test run in connection with a method according to an embodiment of the present invention.

FIG. 4 illustrates schematically an elevator system according to an embodiment of the present invention.

### DETAILED DESCRIPTION OF SOME EMBODIMENTS

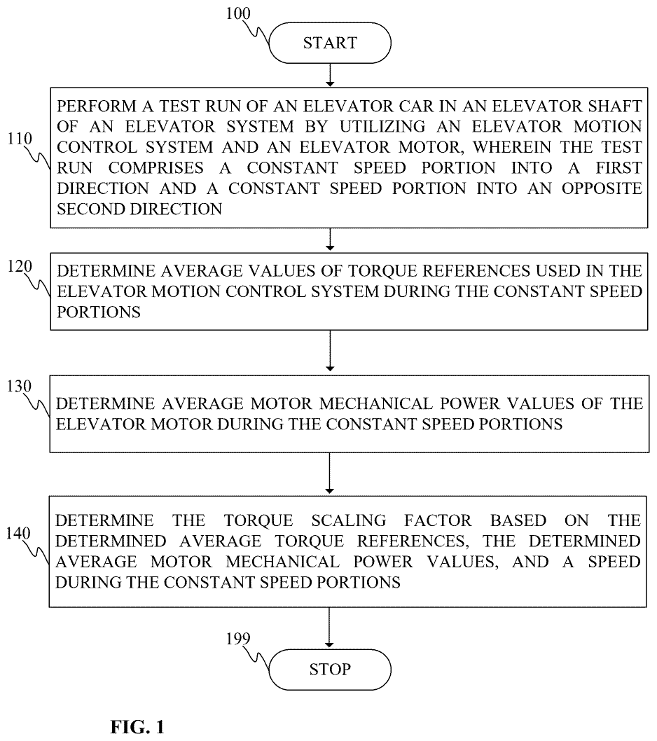

FIG. 1 shows a flow diagram of a method for determining a torque scaling factor according to an embodiment of the present invention. Item, or method step, 100 refers to a start-up phase of the method. Suitable equipment and components may be obtained, and systems assembled and configured for operation. This may mean manufacturing an elevator system and setting it up, or the elevator system may be ready for commissioning and/or test runs. Alternatively, the elevator may have been used already but set (temporarily) into a maintenance mode or the like for performing the test run.

Item, or method step, 110 refers to performing a test run of an elevator car in an elevator shaft of an elevator system by utilizing the elevator motion control system and the elevator motor, wherein the test run comprises a constant speed portion into a first direction and a constant speed portion into an opposite second direction.

Item, or method step, 120 refers to determining, such as by an elevator motion controller, average values of torque references used in the elevator motion control system during the constant speed portions.

Item, or method step, 130 refers to determining, such as by an elevator motion controller, average motor mechanical power values of the elevator motor during the constant speed portions.

Item, or method step, 140 refers to determining, such as by an elevator motion controller, the torque scaling factor based on the determined average torque references, the determined average motor mechanical power values, and a speed during the constant speed portions, for example, an absolute value of the speed.

Method execution may be stopped at item 199. The determined torque scaling factor may be inputted or stored into memory and optionally used in controlling of the operation of the elevator or hoisting motor, such as by the elevator motion control system. The torque scaling factor may then be used in controlling the movement of the elevator car during the normal operation mode of the elevator system.

The torque scaling factor is, preferably, a relation between a torque reference and an output power of the elevator motor. Furthermore, more specifically, the torque scaling factor may be a ratio of the torque reference of the elevator motion control system to the output power, the output power being mechanical output power.

In various embodiments, the method may comprise determining the speed based on measuring a rotational speed of the elevator motor. The speed may be determined, for example, by a measurement using a motor encoder.

In some other embodiments, the method may comprise determining the speed based on measuring speed of the elevator car and using one or more mechanical force transmission parameters related to force transmission between the elevator motor and the elevator car. The speed measurement may be performed, for example, by a sensor arrangement for determining the elevator position and/or speed in the elevator shaft.

The one or more mechanical force transmission parameters may be, for example, a roping factor and a radius of the traction sheave. The roping ratio may refer to the amount of hoisting rope that the elevator motor has to move in order to raise the elevator car by a desired distance.

Furthermore, in some preferable embodiments, the torque scaling factor may be determined based on the following equation:

$${K}_{T} = \frac{{T}_{REF , UP} + {T}_{REF , DOWN}}{{P}_{MOTOR , UP} - {P}_{MOTOR , DOWN}} . \frac{{V}_{TEST} \cdot {I}_{R}}{R} ,$$

where K_{T} is the torque scaling factor, T_{REF,UP} is the average value of torque reference during the constant speed portion into the first direction, T_{REF,DOWN} is the average value of torque reference during the constant speed portion into the opposite second direction, P_{MOTOR,UP} is the average motor mechanical power value during the constant speed portion into the first direction, P_{MOTOR,DOWN} is the average motor mechanical power value during the constant speed portion into the opposite second direction, V_{TEST} is the speed during the constant speed portions, IR is the roping ratio of the elevator system, and R is a radius of a traction sheave of the elevator system.

In various embodiments, the method may further comprise determining the motor mechanical power based on a stator resistance of the elevator motor, and on a motor current and a motor voltage during the constant speed portions. For example, the determining of the motor mechanical power may be based on an alpha-beta transformation of motor phase currents and motor phase voltages. In an embodiment, the determining of the motor mechanical power is based on the following equation:

$${P}_{motor} = \frac{3}{2} ( {i}_{S α} \cdot {u}_{S α} + {i}_{S β} \cdot {u}_{S β} ) - \frac{3}{2} {R}_{S} ( {i}_{S α}^{2} + {i}_{S β}^{2} ) ,$$

where i_{Sα} and i_{Sβ} are the alpha-beta transformations of the phase currents of a motor stator, and u_{Sα} and u_{Sβ} are the alpha-beta transformations of the phase voltages of a motor stator, and R_{S} is the stator resistance of the elevator motor.

For example, in the alpha-beta transformation, as is known, a stator current (space) vector may be determined by:

$$[ \begin{matrix}{i}_{S α} \\ {i}_{S β}\end{matrix} ] = [ \begin{matrix}\frac{2}{3} & - \frac{1}{3} & - \frac{1}{3} \\ 0 & \frac{1}{\sqrt{3}} & - \frac{1}{3}\end{matrix} ] [ \begin{matrix}{i}_{S α} \\ {i}_{S β} \\ {i}_{S c}\end{matrix} ] ,$$

where iSa, iSb, and iSc are the stator phase currents.

Furthermore, the method may comprise scaling a torque feedforward used in the elevator motion control system by the determined torque scaling factor. The scaling may comprise also, in addition to the torque feedforward, scaling a speed controller output of the elevator motion control system by the determined torque scaling factor.

The method may comprise measuring one or more motor currents by one or more current sensors, and transmitting measurement results of said measuring to an elevator motion controller of the elevator motion control system.

Alternatively or in addition, the method may comprise measuring one or more motor voltages by one or more voltage sensors, and transmitting measurement results of said measuring to an elevator motion controller of the elevator motion control system.

In various embodiments, the determination of the average values of torque references, the average motor mechanical power values, and, subsequently, the torque scaling factor are performed by an elevator motion controller of the elevator motion control system, the elevator motion controller being connected to the electric converter unit.

The elevator motion controller may be configured to provide the scaled torque reference, which has been scaled by the determined torque scaling factor, to the electric converter unit.

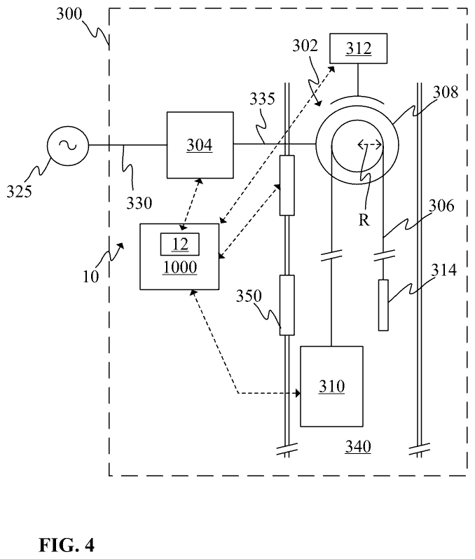

In various embodiments, the elevator motion controller 12 and/or the elevator control unit (marked as 1000 in FIG. 4) may be configured to run a computer program product comprising instructions which, when the program is executed by a processor unit, the method as shown and discussed in connection with FIG. 1 is being performed.

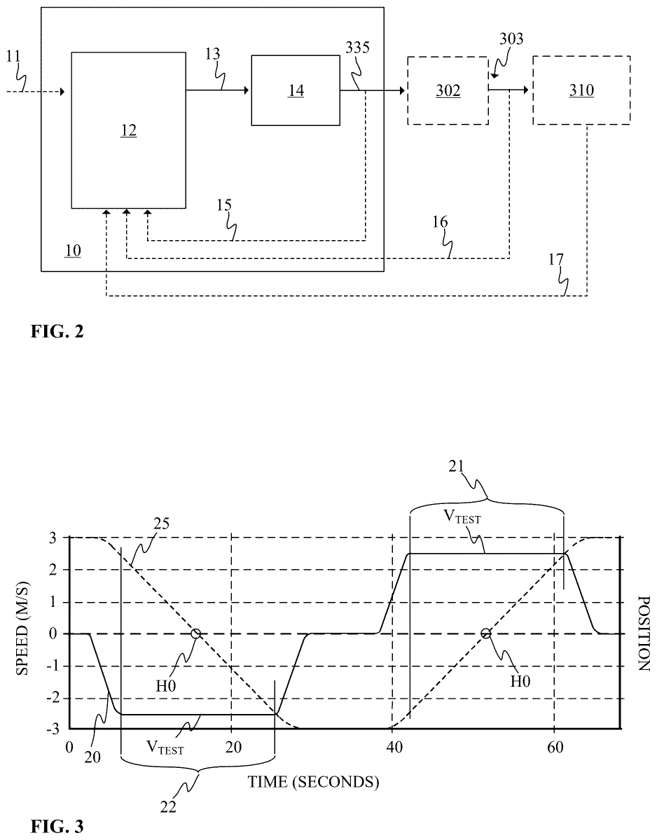

FIG. 2 illustrates schematically an elevator motion control system 10. The elevator motion control system 10 comprises an elevator motion controller 12 connected to an electric converter unit 14, such as a frequency converter, for operating an elevator motor 302.

The elevator motion controller 12 and optionally the electric converter unit 14 comprise one or more processor units (not shown) which include processor(s) and memory, such as non-transitory/non-volatile memory devices. The processor units are, preferably, programmable, may hold pre-defined values stored therein, such as information about the one or more force transmission parameters, including roping ratio of the elevator system and/or the radius of a traction sheave of the elevator system. Furthermore, the processor units may be arranged to receive measurement data from one or more sensors, such as an elevator motor speed sensor, an elevator car speed sensor, current and voltage sensors for measuring elevator motor current(s) and voltage(s). Furthermore, the processor units may be configured to perform the alpha-beta transformation and/or various other tasks.

The elevator motion control system 10 is, preferably, configured at least to perform a test run of an elevator car in an elevator shaft of an elevator system by utilizing the elevator motion control system 10 and the elevator motor 14, wherein the test run comprises a constant speed portion into a first direction and a constant speed portion into an opposite second direction, determine average values of torque references used in the elevator motion control system 10 during the constant speed portions, determine average motor mechanical power values of the elevator motor 302 during the constant speed portions, and determine the torque scaling factor based on the determined average torque references, the determined average motor mechanical power values, and a speed during the constant speed portions, for example, an absolute value of the speed.

As shown in FIG. 2, the elevator motion controller 12 may be arranged to provide input signal/data 13 to the electric converter unit 14. For example, the input signal may be a torque reference or a torque feedforward.

The elevator motion controller 12 may be configured to comprise the torque scaling factor once it has been determined or received. Thus, the torque reference 13 or the torque feedforward 13 may be scaled by the torque scaling factor before being provided to the electric converter unit 14. Alternatively, the torque scaling factor could be in the electric converter unit 14 and configured to scale the torque reference being inputted thereto.

In some embodiments, optionally, the scaling may comprise also, that is in addition to the scaling of torque reference 13 or torque feedforward 13, scaling a speed controller output of the elevator motion control system 10 by the determined torque scaling factor.

Optionally, the elevator motion control system 10 and/or the elevator motion controller 12 may be configured to receive input signal/data from outside the elevator motion control system 10, such as from other devices of the elevator system or even outside the elevator system. Such input signal may include information about changing the mode of operation from the normal operation mode to a maintenance mode. Alternatively or in addition, the input signal may include a command to perform the test run.

As can be seen in FIG. 2, there may be a first feedback signal 15 from the output of the electric converter unit 14 to the elevator motion controller 12. The first feedback signal 15 may be or relate to, for example, the torque applied to the elevator motor 302 via a connection 335. For example, the torque applied may be determined by a current and/or voltage measurement(s), such as phase currents and/or phase voltages. It may require certain calculations to be performed in order to get the torque value from the current and/or voltage values, as is known.

Alternatively or in addition, there may be a second feedback signal 16 from the output 303 of the elevator motor 302, that is the rotational speed of the motor 302. On the other hand, the second feedback signal may be rotational speed of the traction sheave (not shown in FIG. 2). As described hereinbefore, the output 303 of the motor 302 may not directly give information about the speed of the elevator car 310. However, by utilizing one or more force transmission parameters between the motor 302 and the elevator car 310, such as the roping ratio and, optionally, the radius of the traction sheave (not shown), the output 303 can be used to estimate, such as by calculation, the speed of the elevator car 310.

Alternatively or in addition, there may be a third feedback signal 17 from the elevator car 310 or from a sensor of in the elevator shaft (not shown in FIG. 2). For example, the third feedback signal may include information about the position and/or speed of the elevator car 310.

In various embodiments, there may be used only one of the above-disclosed feedback signals, or two of them, or even all of them being utilized. The elevator motion control system 10 may thus use any one or more of the feedback signals to control the elevator motor 302 and movement of the elevator car 310 during the test run. Of course, same applies also to operation during the normal operation mode.

FIG. 3 illustrates schematically characteristics of a test run in connection with a method according to an embodiment of the present invention. FIG. 3 illustrates the test run as a graph, on the horizontal axis of which is time (in seconds), on the vertical axis on the left is the speed of the elevator car (in meters per second), and on the vertical axis on the right is the position of the elevator car in the elevator shaft. The units of the position may be meters, such as in relation to the bottommost floor (being zero), or floor numbers or the like.

In FIG. 3, the speed curve is marked with reference sign 20. On the speed curve 20, two constant speed portions 21, 22 are indicated to be between vertical lines. The position curve is marked with reference sign 25. Positive values for speed indicate that the elevator car is moving into the first direction, preferably, upwards. Negative values for speed indicate that the elevator car is moving into the opposite second direction, preferably downwards.

Marked with circles on the position curve 25 are the middle points H0 of the elevator shaft. In this graph, the middle point of the shaft coincides with zero speed as visible in the graph. This is merely a choice to make the graph as easily readable as possible.

In this particular example, an embodiment is described in which the elevator car covers substantially the same section of the elevator shaft during the two constant speed portions 21, 22 as becomes clear when looking at the portions of the position curve 25 defined by the vertical lines also defining the constant speed portions 21, 22 on the speed curve 20. Furthermore, the middle point H0 of the elevator shaft is, although doesn't necessarily have to be, substantially in the center of the sections of the shaft covered by the elevator car during the constant speed portions 21, 22.

Furthermore, in FIG. 3, an example is illustrated where the elevator car is moved from the bottommost floor (coinciding with “−3” on the left vertical axis) to the topmost floor (coinciding with “3” on the right vertical axis). In some embodiments, the height of the shaft may be in the range of 5 to 100 meters, preferably from 10 to 80 meters, such as about 60 meters.

As can further be seen in FIG. 3, during the test run, the elevator car may additionally be stopped for some time(s) (the speed being zero) at some portions of the test run, such as at the extreme points thereof (for example, at the bottommost and the topmost floors). These stopping portions do not qualify as the constant speed portions, since during the constant speed portions, the speed V_{TEST} of the elevator car 310 must be higher than zero.

FIG. 4 illustrates schematically an elevator system 300 according to an embodiment of the present invention. The elevator system 300 comprises the elevator motion control system 10. The elevator system 300 comprises an elevator, or “hoisting”, motor 302, such as a permanent magnet electric motor, for moving an elevator car 310 comprised in the elevator system 300. The elevator car 310 may be mechanically coupled to the electric motor 302, preferably, by a hoisting rope 306. The operation of the electric motor 302 may be controlled by an electric converter 304 such as a frequency converter or an inverter. The elevator car 310 is moved in the elevator shaft 340 in the normal operation mode so as to serve landing floors 350.

The hoisting rope 306 may comprise, for example, steel or carbon fibers. The term ‘hoisting rope’ does not limit the form of the element anyhow. For example, the hoisting rope 306 may be implemented as a rope or a belt.

The elevator motor 302 may be arranged in mechanical coupling with a traction sheave 308. Furthermore, the elevator rope 304 may be arranged to run via the traction sheave 308 in order for the elevator motor 302 to be able to move the elevator car 310 coupled to the hoisting rope 302. Still further, being connected to the hoisting rope 302, may preferably be a counterweight 314 for the elevator car 310. Although shown in FIG. 4 that the hoisting rope 306 would be attached from one end to the elevator car 310 and from the opposite end to the counterweight 314, and then simply running via the traction sheave 308, in practice, the hoisting rope 306 may run via one or several other sheaves and components, as known to a skilled person in the art. Thus, depending how the hoisting rope 306 is arranged to run, for example, past how many sheaves and how such configuration is designed and arranged, the roping ratio may be different from one elevator system 300 to another.

The elevator system 300 may comprise an elevator control unit 1000 for controlling the operation of the elevator system 300, such as various devices thereof. The elevator control unit 1000 may be a separate device or may be comprised in the other components of the elevator system 300 such as in or as a part of the electric converter 304. In various embodiments, the elevator control unit 1000 comprises the electric converter 304.

In some embodiments, the elevator control unit 1000 may comprise the elevator motion controller 12, as shown in FIG. 4, however, in other embodiments, they may be separate entities, in which case the elevator control unit 1000 may be in communication connection with the elevator motion controller 12, such as providing input signal/data 11 thereto.

The elevator control unit 1000 may also be implemented in a distributed manner so that, e.g., one portion of the elevator control unit 1000 may be comprised in the electric converter 304 and another portion in the elevator car 310, for instance. The elevator control unit 1000 may also be arranged in distributed manner at more than two locations or in more than two devices. As can be seen in FIG. 4, the elevator control unit 1000 may be arranged to at least communicate (examples of such connections being shown with dashed two-headed arrows) with various devices of the elevator system 300.

The elevator system 300 may comprise an elevator brake arrangement 312 comprising an elevator brake, preferably, an electromechanical elevator brake.

Other elements, shown in FIG. 4 are a main electrical power supply 325 such as a three- or single-phase electrical power grid, an electrical connection 330 between the power supply 325 and the electric converter 304, another electrical connection 335 between the electric converter 304 and the electric motor 302.

1. A method for determining a torque scaling factor for an elevator motion control system connected to and configured to operate an elevator motor, the method comprising:
performing a test run of an elevator car in an elevator shaft of an elevator system by utilizing the elevator motion control system and the elevator motor, wherein the test run comprises a constant speed portion into a first direction and a constant speed portion into an opposite second direction,
determining, such as by an elevator motion controller, average values of torque references used in the elevator motion control system during the constant speed portions,
determining, such as by an elevator motion controller, average motor mechanical power values of the elevator motor during the constant speed portions, and
determining, such as by an elevator motion controller, the torque scaling factor based on the determined average torque references, the determined average motor mechanical power values, and a speed during the constant speed portions.

2. The method of claim 1, wherein the torque scaling factor is a relation between a torque reference and an output power of the elevator motor.

3. The method of claim 2, wherein the torque scaling factor is a ratio of the torque reference of the elevator motion control system to the output power, the output power being mechanical output power.

4. The method ofany of claim 1, comprising determining the speed based on measuring a rotational speed of the elevator motor.

5. The method of claim 1, comprising determining the speed based on measuring speed of the elevator car and using one or more mechanical force transmission parameters related to force transmission between the elevator motor and the elevator car.

6. The method of claim 5, wherein the torque scaling factor is determined based on the following equation:
$${K}_{T} = \frac{{T}_{REF , UP} + {T}_{REF , DOWN}}{{P}_{MOTOR , UP} - {P}_{MOTOR , DOWN}} . \frac{{V}_{TEST} \cdot {I}_{R}}{R} ,$$
where K_{T} is the torque scaling factor, T_{REF,UP} is the average value of torque reference during the constant speed portion into the first direction, T_{REF,DOWN} is the average value of torque reference during the constant speed portion into the opposite second direction, P_{MOTOR,UP} is the average motor mechanical power value during the constant speed portion into the first direction, P_{MOTOR,DOWN} is the average motor mechanical power value during the constant speed portion into the opposite second direction, V_{TEST} is the speed during the constant speed portions, IR is a roping ratio of the elevator system, and R is a radius of a traction sheave of the elevator system.

7. The method of claim 1, comprising determining the motor mechanical power based on a stator resistance of the elevator motor, and on a motor current and a motor voltage during the constant speed portions.

8. The method of claim 7, wherein the determining of the motor mechanical power is based on an alpha-beta transformation of motor phase currents and motor phase voltages.

9. The method of claim 8, wherein the determining of the motor mechanical power is based on the following equation:
$${P}_{motor} = \frac{3}{2} ( {i}_{S α} \cdot {u}_{S α} + {i}_{S β} \cdot {u}_{S β} ) - \frac{3}{2} {R}_{S} ( {i}_{S α}^{2} + {i}_{S β}^{2} ) ,$$
where i_{Sα} and i_{Sβ} are the alpha-beta transformations of the phase currents of a motor stator, and u_{Sα} and u_{Sβ} are the alpha-beta transformations of the phase voltages of a motor stator, and R_{S} is the stator resistance of the elevator motor.

10. The method of claim 1, comprises scaling a torque feedforward used in the elevator motion control system by the determined torque scaling factor.

11. The method of claim 10, wherein the scaling comprises also scaling a speed controller output of the elevator motion control system by the determined torque scaling factor.

12. The method of claim 1, comprising measuring one or more motor currents by one or more current sensors, and transmitting measurement results of said measuring to an elevator motion controller of the elevator motion control system.

13. The method of claim 1, comprising measuring one or more motor voltages by one or more voltage sensors, and transmitting measurement results of said measuring to an elevator motion controller of the elevator motion control system.

14. The method of claim 1, wherein the determination of the average values of torque references, the average motor mechanical power values, and, subsequently, the torque scaling factor are performed by an elevator motion controller of the elevator motion control system, the elevator motion controller being connected to the electric converter unit.

15. The method of claim 10, wherein the elevator motion controller is configured to provide the scaled torque reference, which has been scaled by the determined torque scaling factor, to the electric converter unit.

16. An elevator motion control system, comprising an elevator motion controller connected to an electric converter unit for operating an elevator motor, the elevator motion control system being configured to:
perform a test run of an elevator car in an elevator shaft of an elevator system by utilizing the elevator motion control system and the elevator motor, wherein the test run comprises a constant speed portion into a first direction and a constant speed portion into an opposite second direction,
determine average values of torque references used in the elevator motion control system during the constant speed portions,
determine average motor mechanical power values of the elevator motor during the constant speed portions, and
determine the torque scaling factor based on the determined average torque references, the determined average motor mechanical power values, and a speed during the constant speed portions.

17. An elevator system, comprising
an elevator car movable in an elevator shaft by an elevator motor, and
an elevator motion control system of claim 16, wherein the electric converter unit is connected to the elevator motor.

18. A non-transitory computer readable medium storing a computer program comprising instructions which, when the program is executed by a processor unit of an elevator motion control system, cause the elevator motion control system to carry out the method of claim 1.

19. The method of claim 2, comprising determining the speed based on measuring a rotational speed of the elevator motor.

20. The method of claim 3, comprising determining the speed based on measuring a rotational speed of the elevator motor.
